(19) United States
(12) Patent Application Publication
(10) Pub. No.: US 2024/0416779 A1
(43) Pub. Date: Dec. 19, 2024

(54) INTEGRATED POWER DISTRIBUTION UTILITY PANEL

(71) Applicant: Franklin Fueling Systems, LLC, Madison, WI (US)

(72) Inventors: Randall Boucher, Saco, ME (US); Justin F. Kuehn, Sun Prairie, WI (US); Balaji Swaminathan, Madison, WI (US)

(73) Assignee: Franklin Fueling Systems, LLC, Madison, WI (US)

(21) Appl. No.: 18/703,329

(22) PCT Filed: Oct. 20, 2022
(86) PCT No.: PCT/US2022/078460

§ 371 Date: Apr. 19, 2024

Related U.S. Application Data
(60) Provisional application No. 63/257,790, filed on Oct. 20, 2021.
(60) Provisional application No. 63/277,687, filed on Nov. 10, 2021.
(60) Provisional application No. 63/394,478, filed on Aug. 2, 2022.

(51) Int. Cl. B60L 53/51; B60L 53/60

(52) U.S. Cl. CPC B60L 53/51; B60L 53/60; B60L 2210/30; B60L 2210/40

(57) ABSTRACT

A power distribution utility panel is provided with a first panel area configured to be accessed only by personnel of a utility, the first panel area including a current transformer, a second panel area including at least one remote controllable device for connecting and disconnecting power to/from one or more loads, and a third panel area including at least one power converter assembly, a controller and a power meter configured to monitor power from a power source, the at least one power converter assembly being configured to route power from the power source to an electric vehicle charger and/or an energy storage system.

### BACKGROUND

As the population of electric vehicles gains market share and becomes more widely adopted, existing fueling infrastructures for non-electric vehicles will need to be adapted or otherwise augmented to provide electric charging capabilities. For example, existing fueling stations that may include amenities such as mini-markets, restaurants, and break facilities in addition to providing access to a liquid fueling infrastructure such as fuel pumps, fuel tanks, and fuel distribution systems, may be modified to include a charging infrastructure to support electric vehicle charging needs. While many level 1, level 2, and level 3 electric vehicle chargers can be connected to an existing electrical utility provider, care must be taken to ensure that the electrical utility provider can provide the energy requirements of the electric vehicle charging needs at all hours of the day.

### SUMMARY

To augment fueling stations with electric vehicle charging capabilities one or more components for charging an electric vehicle are to be located at or near the fueling station. In examples, an infrastructure for providing electrical energy to one or more electric vehicles chargers is described herein. The infrastructure may include a power distribution board coupled to and configured to receive energy from a transformer, a renewable energy source, and an energy storage system. In examples, a multi-directional power converter assembly is configured to receive energy from the power distribution board and the renewable energy source, convert the received energy into direct current, and cause the energy to be stored in the energy storage system. Accordingly, existing fueling stations when provided with an electric infrastructure described herein, can meet the charging needs and requirement of one or more electric vehicles.

According to one embodiment of the disclosure, an energy management system is provided, comprising: a power distribution board configured to receive AC energy from a transformer coupled to a first energy supply and to output energy to a vehicle charger; a power converter assembly configured to receive AC energy through a first disconnect from the power distribution board and convert the AC energy to DC energy; an energy storage system coupled to the power converter assembly to receive and store DC energy from the power converter assembly; and a controller coupled to the power distribution board, the power converter assembly and the energy storage system, the controller being configured to cause the power converter assembly to receive DC energy from the energy storage system, convert the DC energy to AC energy, and provide the AC energy to the power distribution board; wherein the power distribution board, the power converter assembly, the energy storage system and the controller are located within a container. One aspect of this embodiment further comprises a second disconnect connected between the transformer and the first energy supply. In another aspect, the controller is further configured to cause the power converter assembly to receive DC energy from the energy storage system, convert the DC energy to AC energy, and provide the AC energy to the power distribution board for delivery through the first disconnect to the transformer and the first energy supply. Another aspect further comprises a renewable energy source configured to provide energy through a power converter to the power converter assembly, wherein the controller is configured to cause the power converter assembly to deliver power received from the renewable energy source to the energy storage system. In a variant of this aspect, the controller is configured to determine when a requisite amount of energy is available for a particular load from the renewable energy source and respond to such determination by causing the renewable energy source to provide energy through the power converter to the power distribution board instead of the energy storage system. In another variant, the controller is configured to cause the power distribution board to output energy to the vehicle charger including energy from the transformer and energy from the renewable energy source. In a further variant, the energy from the renewable energy source output by the power distribution board is energy stored in the energy storage system. In yet another aspect of this embodiment, the controller is configured to receive communications from one or more sensors associated with the vehicle charger and control operation of the energy management system in response to the communications. In a variant of this aspect, the one or more sensors includes a vapor sensor that communicates a measurement to the controller of a combustible fuel vapor. In another variant, the one or more sensors includes a crash sensor that communicates a signal to the controller indicating an impact to the container and/or the vehicle charger. In still another variant, the controller controls operation of the energy management system in response to the communications by automatically disconnecting energy supplied to the vehicle charger. In yet another variant, the one or more sensors includes a liquid sensor that communicates a measurement to the controller of a level of liquid in a measured area. In another aspect of this embodiment, the controller includes an environment monitor sub-controller configured to monitor at least one of temperature, humidity and pressure within the container and to operate one or more environmental systems to maintain one or more parameters of an operating environment within the container. Still another aspect further comprises a user computing device having a graphical user interface configured for wireless communication via one or more communications networks with the controller and an information database to permit the user to access information from the information database and configure one or more parameters of operation of the energy management system based upon the accessed information. In a variant of this aspect, the graphic user interface further permits the user to perform remote diagnostics and/or control of the energy management system by sending one or more commands to the controller via the one or more communications networks.

In another embodiment of the present disclosure, a power distribution utility panel is provided, comprising: a first panel area configured to be accessed only by personnel of a utility, the first panel area including a current transformer; a second panel area including at least one remote controllable device for connecting and disconnecting power to/from one or more loads; and a third panel area including at least one power converter assembly, a controller and a power meter configured to monitor power from a power source, the at least one power converter assembly being configured to route power from the power source to an electric vehicle charger and/or an energy storage system. One aspect of this embodiment further comprises a fourth panel area including the energy storage system which includes a plurality of energy storage devices. In another aspect, each of the panel areas include a separate access panel and is electrically and magnetically isolated from adjacent panel areas. In another aspect, the second panel area includes a one or more power and/or health monitors configured to monitor a main power supply from a utility and power provided to the electric vehicle charger. In a variant of this aspect, the first panel area includes three phase main breaker feeder cables coupled to underground utility service connections. In another aspect of this embodiment, the at least one remote controllable device includes at least one circuit breaker and at least one relay. Another aspect further comprises a safety monitoring module including an electric vehicle crash sensor module, a vapor monitoring module, a liquid monitoring module, an emergency stop module, and a communications module. In one variant of this aspect, the communications module is configured to communicate with a user computing device having a graphic user interface that permits the user to perform remote diagnostics and/or control of the power distribution utility panel by sending one or more commands to the communications module. In another variant, the electric vehicle crash sensor module is coupled to one or more crash sensors configured to sense an impact to the power distribution utility panel and/or the electric vehicle charger. In still another variant, the vapor monitoring module is coupled to one or more vapor sensors configured to measure an amount of a flammable vapor in a vicinity of the power distribution utility panel. In yet another variant, the liquid monitoring module is coupled to one or more liquid sensors configured to measure a level of liquid in a measured area. In a further variant, the one or more liquid sensors are disposed in one of the electric vehicle charger or the power distribution utility panel. In yet another variant, the emergency stop module is configured to communicate via the communications module with the controller to cause electricity to be disconnected from the electric vehicle charger based upon inputs from the electric vehicle crash sensor module and/or the vapor monitoring module. In a further variant, the emergency stop module communicates via the communication module with the controller to cause electricity to be disconnected from the electric vehicle charger based upon an emergency stop input from an emergency stop device located on at least one of the electric vehicle charger and the power distribution utility panel.

In another embodiment, the present disclosure provides a method of managing energy distribution, comprising: determining, by a controller, energy storage specifications; configuring, by the controller, a power converter based upon the determined energy storage specification to receive energy from a renewable energy source and to provide energy to a power conversion device; converting, by the power conversion device, the received energy from a first form to a second form and/or to a different voltage based upon the energy storage specifications; providing the converted energy to a power combiner board; and storing energy received from the power combiner board in an energy storage device.

In yet another embodiment, the present disclosure provides a method of managing energy distribution, comprising: determining, by a controller, energy storage specifications; configuring, by the controller, a power converter based upon the determined energy storage specification to receive energy from a renewable energy source and to provide energy to a power conversion device; converting, by the power conversion device, the received energy from a first form to a second form and/or to a different voltage based upon the energy storage specifications; receiving an indication of an about of energy capable of being provided by the renewable energy source; determining, by the controller, whether additional energy is needed to augment the energy capable of being provided by the renewable energy source; identifying, by the controller, in response to determining that additional energy is needed, one or more additional energy sources as being an electric storage device and/or an electric utility source; configuring, by the controller, a power combiner board to combine the energy capable of being provided by the renewable energy source with energy from the one or more additional energy sources; and outputting, by the power combiner board, the combined energy to an electric vehicle charger.

In still another embodiment, the present disclosure provides a method of managing energy distribution, comprising: determining, by a controller, energy storage specifications; configuring, by the controller, a power converter based upon the determined energy storage specification to receive energy from an electrical utility provider and to provide energy to a power combiner board; converting, by a power conversion device, the received energy from based upon the energy storage specifications; providing the converted energy to the power combiner board; and receiving the converted energy from the power combiner board for storage by an energy storage device.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 depicts details of a fueling station augmented with an electric charging infrastructure that provides access to electric vehicle charging in accordance with examples of the present disclosure.

FIG. 2A depicts a block diagram and details of an energy conversion and storage system 200A in accordance with examples of the present disclosure.

FIG. 2B depicts a block diagram and details of an energy conversion system 200B in accordance with examples of the present disclosure.

FIG. 3 depicts a block diagram and details of an energy conversion and storage system 300 in accordance with examples of the present disclosure.

FIG. 4 depicts additional details of a controller, transformer monitor, and site controller, in accordance with examples of the present disclosure.

FIG. 5 depicts details directed to controlling one or more of the controller, site controller, and/or transformer monitor in accordance with examples of the present disclosure.

FIG. 6 depicts a method for charging or otherwise storing energy in one or more energy storage devices in accordance with examples of the present disclosure.

FIG. 7 depicts a first method for providing energy from an energy conversion and storage system in accordance with examples of the present disclosure.

FIG. 8 depicts a second method for providing energy from an energy conversion and storage system in accordance with examples of the present disclosure.

FIG. 9 depicts a block diagram illustrating physical components (e.g., hardware) of a computing device with which aspects of the disclosure may be practiced in accordance with examples of the present disclosure.

FIG. 10 illustrates an exemplary mobile computing device and/or server that may execute one or more aspects disclosed herein in accordance with examples of the present disclosure.

FIG. 11 depicts an example integrated power distribution utility panel in accordance with examples of the present disclosure.

FIG. 12 depicts additional details of an example integrated power distribution utility panel in accordance with examples of the present disclosure.

FIG. 13 depicts additional details of an example integrated power distribution utility panel in accordance with examples of the present disclosure.

FIG. 14 depicts additional details of an example integrated power distribution utility panel in accordance with examples of the present disclosure.

FIG. 15 depicts additional details of a power and health monitor in accordance with examples of the present disclosure.

FIG. 16 depicts details of a safety monitoring module in accordance with examples of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As the population of electric vehicles gains market share and becomes more widely adopted, existing fueling infrastructures for non-electric vehicles will need to be adapted or otherwise augmented to provide electric charging capabilities. For example, existing fueling stations that may include amenities such as mini-markets, restaurants, and break facilities in addition to providing access to a liquid fueling infrastructure such as fuel pumps, fuel tanks, and fuel distribution systems, may be modified to include a charging infrastructure to support electric vehicle charging needs. While many level 1, level 2, and level 3 electric vehicle chargers can be connected to an existing electrical utility provider, care must be taken to ensure that the electrical utility provider can provide the energy required for charging electric vehicles at all hours of the day. Furthermore, as access to renewable energy becomes more prevalent and cost efficient, an electric vehicle charging infrastructure can tap these renewable energy sources and make them available to end-consumers.

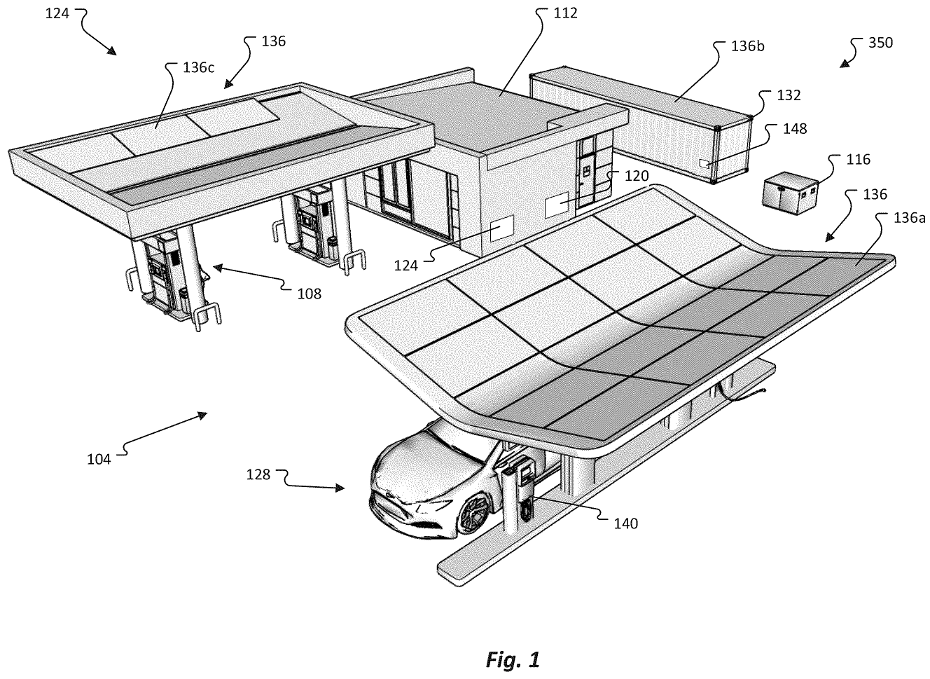

FIG. 1 depicts details of a fueling station augmented with an electric charging infrastructure that provides access to electric vehicle charging in accordance with examples of the present disclosure. The fueling station 104 may include existing liquid petroleum pumps 108 used to transfer liquid petroleum from one or more on-site liquid petroleum tanks to a non-electric vehicle. As previously mentioned, the fueling station 104 may include additional amenities accessible within a mini-mart 112 for example. The minimart 112 may be coupled to an existing electrical utility provider via one or more transformers 116 and/or one or more electrical disconnects 120. In examples, and as will be described herein, a site controller 124 may control the distribution and monitoring of liquid fueling resources (e.g., controlling one or more liquid pumps responsible for providing liquid petroleum from the one or more on-site liquid petroleum tanks to a petroleum pump 108). Further, the site controller 124 may receive sensor information from one or more liquid sensors indicating an amount of fuel remaining in each of the one or more tanks. In some examples, the site controller 124 may receive sensor information from one or more sensors configured to detect the presence of petroleum outside of the one or more on-site liquid petroleum tanks.

To augment the fueling station 104 such that fueling station 104 includes one or more components for charging an electric vehicle, such as the electric vehicle 128, the fueling station 104 may include one or more energy conversion and storage systems which may be contained within a container, such as the container 132. In some examples, the container is beneath the ground and/or may comprise a vault. As will be further described, the one or more energy conversion and storage systems may include one or more energy distribution boards, one or more direct current combiner boards, one or more energy storage devices, one or more internal disconnects or switches, and one or more bi-directional energy conversion devices. The one or more energy conversion and storage systems may be coupled to the one or more transformers 116 and receive energy in the form of alternating current (AC) electricity. The AC electricity may be at one or more voltages as determined by or otherwise provided by the one or more transformers 116. In addition, the one or more energy conversion and storage systems may be coupled to a renewable energy source, such as a photovoltaic energy array 136, where the photovoltaic energy array 136 may include a plurality of photovoltaic panels 136a-c configured to convert sunlight into electrical energy. Accordingly, the energy provided by the photovoltaic array 136 may be provided to the one or more energy conversion and storage systems for storage. In some examples, the energy provided by the photovoltaic array 136 may be converted from a first energy type, such as direct current (DC) to a second energy type, such as AC. The energy provided by the photovoltaic array 136 may be provided to an electric vehicle charger 140. In some examples, the energy provided by the photovoltaic array 136 may be augmented with energy provided by the one or more energy conversion and storage systems. For example, the photovoltaic array 136 may not be adequate to service the needs of one or more electric vehicle chargers 140 and/or one or more electric vehicles for various reasons including but not limited to sizing, amount of available sunlight, etc. Thus, the one or more energy conversion and storage systems may augment, or otherwise combine the energy received from the photovoltaic array 136 with energy received from the electrical utility provider and/or from energy previously received from the photovoltaic array 136 and/or electrical utility provider, but stored in an energy storage device, such as a battery. Accordingly, the one or more energy conversion and storage systems may provide electrical energy to the electric vehicle charger 140, where the electrical energy is a combination of on-site generated renewable energy and/or electrical energy received from an electrical utility. A renewable resource may correspond to a replenishable natural resource that replenishes either through natural reproduction or other recurring processes in a finite amount of time. Common sources of renewable energy sources include but are not limited to solar, geothermal, wind, and hydroelectric.

In accordance with examples of the present disclosure, a controller 148 may control and coordinate the transfer of energy received from the electric utility and the transfer of energy received from the photovoltaic array 136. The controller 148 may control and coordinate the charging of the energy storage devices. In examples, the controller 148 may interface with the site controller 124 and provide information as well as receive commands from the site controller 124. In some examples, the site controller 124 may perform all of the functions of the controller 148; accordingly, the one or more energy conversion and storage systems may interface directly with the site controller 124. In examples, the site controller 124 and/or the controller 148 may determine an optimal time for charging the energy storage devices, whether that be from energy sourced from the electrical utility provider through the transformer 116 and/or energy sourced from the photovoltaic array 136. For example, at night the photovoltaic array 136 generally cannot provide the same amount of energy as during the day; accordingly, the site controller 124 and/or the controller 148 may determine that the energy storage devices should be charged at night with electrical energy provided by the electric utility provider. As another example, the cost to charge the energy storage devices may dictate or otherwise be a factor when determining what combination of energy is provided to the energy storage device and/or the electric vehicle charger 140. For example, during peak energy usage times as determined by the electrical utility provider, the cost of electricity may be very high and yet the photovoltaic array 136 may be capable of meeting or exceeding a certain energy need. Alternatively, or in addition, the site controller 124 and/or the controller 148 may seek to limit an amount of energy received from the electrical utility provider based upon a previous agreement. For example, the fueling station 104 may be limited, for example in terms of energy rate tiers etc., to twenty-five kilovolt-amps; however, a level 3 electric vehicle charger may provide 192 kilovolt amps when charging an electric vehicle. Accordingly, the site controller 124 and/or the controller 148 may augment the electrical energy provided by the electrical utility provider to keep all energy sourced from the electrical utility provider under twenty-five kilovolt-amps.

In some examples, the site controller 124 and/or the controller 148 may provide energy received from the photovoltaic array 136 back to the electrical utility provider. For example, the energy conversion and storage system may cause excess energy to be returned to the electrical utility provider via a transformer and/or other switch that determines if energy is going to the energy conversion and storage system or back to the electrical utility provider. In some examples, the energy conversion and storage system may sell energy back to the electrical utility provider, where the energy may be provided from the photovoltaic array 136 and/or one or more energy storage devices.

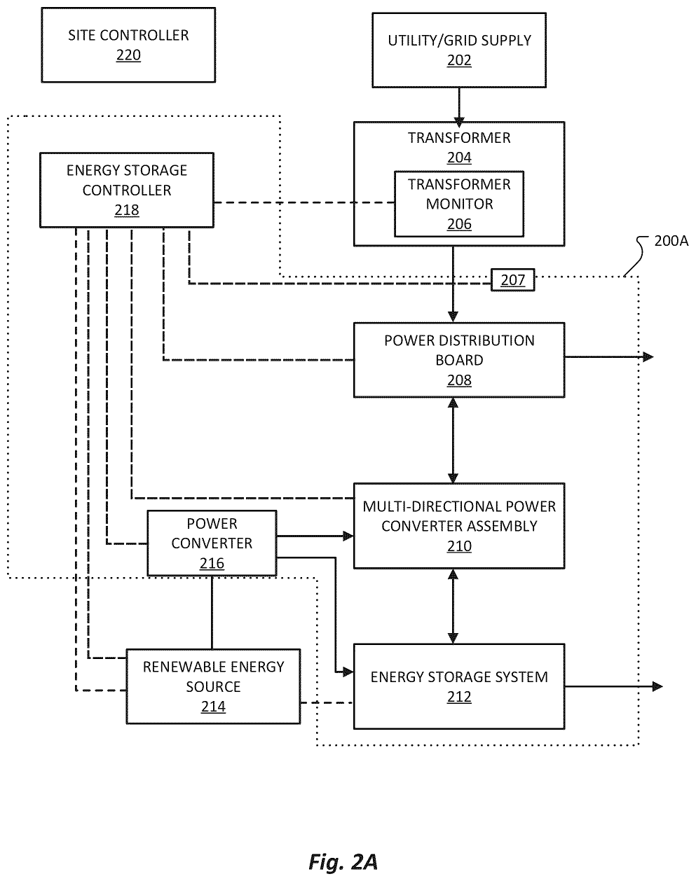

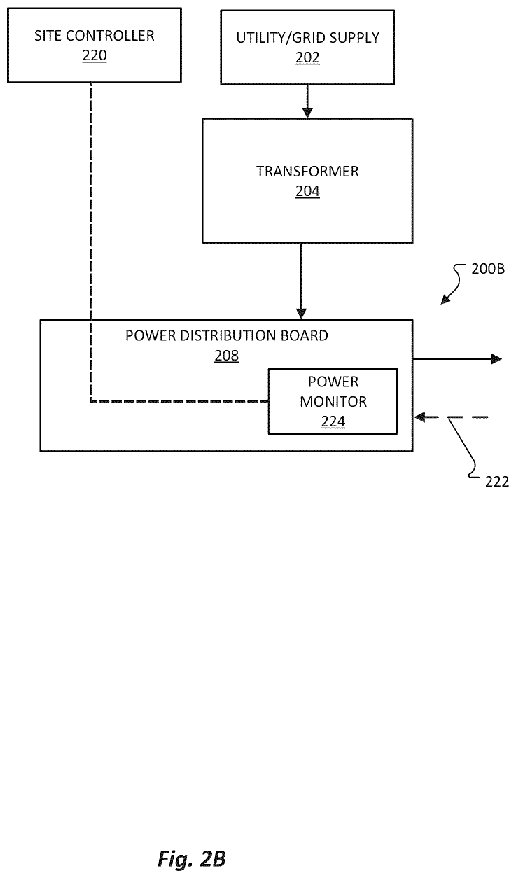

FIG. 2A depicts a block diagram and details of an energy conversion and storage system 200A in accordance with examples of the present disclosure. As depicted in FIG. 2A, an electrical utility provider may provide electricity via the utility/grid supply 202. The utility/grid supply 202 may be coupled to a transformer 204 to step down the voltage provided by the utility/grid supply 202 to a lower voltage. For example, the lower voltage may be 120, 208, 240, 277, and/or 480 volts depending on phase configuration. In examples, a power distribution board 208 may receive energy from the transformer 204 and provide the energy to the multi-directional power converter assembly 210. The multi-directional power converter assembly 210 converts the energy received from the power distribution board 208 from AC form to DC form. Accordingly, the DC energy can be stored in the energy storage system 212. In accordance with examples of the present disclosure, the energy storage system 212 comprises a plurality of energy storage devices, such as but not limited to batteries and/or capacitors.

As further depicted in FIG. 2A, the renewable energy source 214, such as a photovoltaic array 136 (FIG. 1), may provide energy to the energy storage system directly or through a power converter 216. The renewable energy source 214 may output AC energy and/or DC energy at a voltage level other than that which the energy storage system 212 will accept; accordingly, the energy provided by the renewable energy source 214 may be converted to AC for example at the power converter 216 and then provided to the multi-directional power converter assembly 210. In other examples, the energy provided by the renewable energy source 214 may be converted to DC at a different voltage than that which is input at the power converter 216 and then provided to the energy storage system 212.

An energy storage controller 218, which may be the same as or similar to the controller 148 (FIG. 1), may receive information from and/or control each of the multi-directional power converter assembly 210, the power converter 216, the renewable energy source 214, the energy storage system 212, and/or the transformer monitor 206. As previously discussed, the transformer monitor 206 may determine a load that is serviced by the transformer 204 and provide such determination to the energy storage controller 218. The transformer monitor 206 may obtain voltage, current, phase information, and/or total power and provide such information to the energy storage controller 218. In some examples, the energy storage controller 218 may receive information from a meter 207; the meter 207 may determine a load that is serviced by the transformer 204 and provide such determination to the energy storage controller 218. The meter 207 may obtain voltage, current, phase information, and/or total power and provide such information to the energy storage controller 218. The meter 207 may be external to the transformer 204 and/or the container 132.

In examples, the energy storage controller 218 may control the multi-directional power converter assembly 210 such that the multi-directional converter assembly 210 receives energy in the form of DC from the energy storage system 212 and converts the DC energy into AC energy. The power distribution board 208 then receives the AC energy. The power distribution board 208 may then provide the energy as an output of the energy conversion and storage system 200A AC. In some examples, the energy storage controller 218 may determine that there exists a requisite amount of energy from the renewable energy source 214 such that the energy storage system 212 may be bypassed and energy is provided from the renewable energy source 214 to the power distribution board 208. In some examples, the energy received from the renewable energy source 214 may be combined with energy received from the transformer 204. Accordingly, the power distribution board 208 may provide AC energy out, to an electric vehicle charger for example. As some electric vehicle chargers may take as input DC energy, the energy storage system 212 may provide as output DC energy to an electric vehicle charger. In examples, the energy storage controller 218 may configure the energy storage and conversion system 200A depending on the requirements of an electric vehicle charger. In other examples, energy generated by the renewable energy source 214 may be provided to the energy storage system 212.

As previously discussed, the energy storage controller 218 may communicate or otherwise interface with the site controller 220, which may be the same as or similar to the site controller 124 previously described. In examples, the energy storage controller 218 may wirelessly communicate with the site controller 220 such that the energy conversion and storage system 200A is contained within a contained environment, such as a container 132. In other examples, the energy storage controller 218 may communicate with the site controller 220 using another form of communication medium, such as a communication wireline.

FIG. 2B depicts a block diagram and details of an energy conversion system 200B in accordance with examples of the present disclosure. In examples, the energy conversion system 200B may be similar to the energy conversion and storage system 200A; however, one or more energy storage and/or conversion components of the energy conversion system 200A may not be included in the energy conversion system 200B. As depicted in FIG. 2B, an electrical utility provider may provide electricity via the utility/grid supply 202. The utility/grid supply 202 may be coupled to a transformer 204 to step down the voltage provided by the utility/grid supply 202 to a lower voltage. For example, the lower voltage may be 120, 208, 240, 277, and/or 480 volts depending on phase configuration. In examples, a power distribution board 208 may receive energy from the transformer 204 and provide the energy as AC energy to an electric vehicle charger that is in a location that is different from the energy conversion system 200B. The power monitor 224 may determine a load that is serviced by the transformer 204; in examples, the power monitor 224 may be the same as and/or similar to the transformer monitor 206 and may be incorporated into or otherwise reside near the power distribution board 208. The power monitor 224 may obtain voltage, current, phase information, and/or total power and communicate or otherwise interface with the site controller 220, which may be the same as or similar to the site controller 124 previously described. In examples, the site controller 220, the power monitor 224, and/or the power distribution board 208 may be contained within a contained environment, such as a container 132. In other examples, the site controller 220 may reside, in whole or in part, at a cloud services provider or otherwise located at a data center or location that is different from the energy storage conversion system 200B.

In some examples, the site controller 220 and/or the power monitor 224 may receive one or more external communications 222 from an electric vehicle charger. That is, one or more components of an electric vehicle charger (e.g., charging post, etc.) may communicate with the site controller 220 and/or the power monitor 224 to provide charging information, such as but not limited to power consumed, rate of charge, and/or one or more safety statuses. For example, the one or more external communications 222 may provide an indication as to whether a crash has occurred involving an electric vehicle charger, whether the electric vehicle charger is damaged in some manner, and/or whether a crash or damaging event has occurred with a vicinity of the electric vehicle charger. In some examples, the one or more external communications 222 from the electric vehicle charger may provide a status and/or measurement of combustible fuel vapor that is sensed from a vapor sensor. Accordingly, the site controller 220 and/or the power monitor 224 may implement one or more safety protocols (e.g., disconnecting a breaker, removing all or some electricity supplied to electric charger and/or bank of electric chargers) to ensure a safe charging environment.

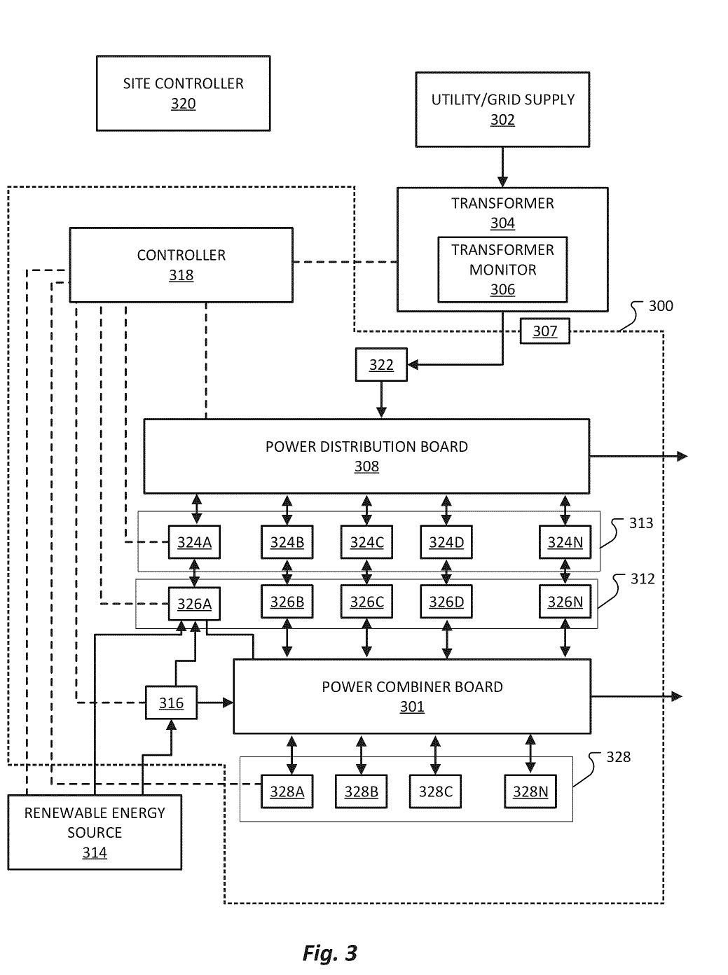

FIG. 3 depicts a block diagram and details of an energy conversion and storage system 300 in accordance with examples of the present disclosure. As depicted in FIG. 3, an electrical utility provider may provide electricity via the utility/grid supply 302; the utility/grid supply 202 may be coupled to a transformer 304 to step down the voltage provided by the utility/grid supply 302 to a lower voltage. For example, the lower voltage may be 120, 208, 240, 277, and/or 480 volts depending on phase configuration. In examples, a power distribution board 308 may receive energy from the transformer 304 through a disconnect 322 and provide the energy to the multi-directional power converter assembly 312 through a disconnect 313. The multi-directional power converter assembly 312 converts the energy received form the power distribution board 308 from AC form to DC form. Accordingly, the DC energy can be stored in the energy storage system 328. In accordance with examples of the present disclosure, the energy storage system 328 comprises a plurality of energy storage devices 328A that may include, but are not limited to, a plurality of batteries and/or capacitors.

As further depicted in FIG. 3, the renewable energy source 314, such as a photovoltaic array 136 (FIG. 1), may provide energy to the energy storage system 328 directly or through a power converter 316. The renewable energy source 314 may output AC energy and/or DC energy at a voltage level other than that which the energy storage system 328 will accept; accordingly, the energy provided by the renewable energy source 314 may be converted to AC for example at the power converter 316 and then provided to the multi-directional power converter assembly 312. In other examples, the energy provided by the renewable energy source 314 may be converted to DC at a different voltage than that which is input at the power converter 316 and then provided to the energy storage system 328.

An energy storage controller, such as the controller 318, which may be the same as or similar to the controller 148 (FIG. 1), may receive information from and/or control one or more components of the energy conversion and storage system 300. As previously discussed, the transformer monitor 306 may determine a load that is serviced by the transformer 304 and provide such determination to the controller 318. The transformer monitor 306 may obtain voltage, current, phase information, and/or total power and provide such information to the controller 318. In some examples, the controller 318 may receive information from a meter 307; the meter 307 may determine a load that is serviced by the transformer 304 and provide such determination to the controller 318. The meter 307 may obtain voltage, current, phase information, and/or total power and provide such information to the controller 318. The meter 307 may be external to the transformer 304 and/or the container 132.

In examples, the controller 318 may control the multi-directional power converter assembly 312 such that the multi-directional converter assembly 312 receives energy in the form of DC from the energy storage system 328 via the power combiner board 301, and converts the DC energy into AC energy. The power distribution board 308 may then be disconnected from the transformer 304 via one or more disconnects 322 controlled by the controller 318, and receive the AC energy. The power distribution board 308 may then provide as output, AC energy to an electrical vehicle charger.

In some examples, the controller 318 may determine that there exists a requisite amount of energy from the renewable energy source 314 such that the energy storage system 328 may be bypassed and energy can be provided from the renewable energy source 314 to the power distribution board 308. Accordingly, the energy from the renewable energy source 314 may be converted to AC energy at the power converter 316 and/or the multi-directional converter assembly 312, and provided to the power distribution board 308 through the disconnect 313. In examples, the multi-directional converter assembly 312 may include a plurality of multi-directional converters 326A-N capable of converting AC energy into DC energy and DC energy into AC energy. In examples, the disconnect 313 may include a plurality of disconnects 324A-N capable of disconnecting a respective multi-directional converter 326A-N from the power distribution board 308.

In some examples, the energy received from the renewable energy source 314 may be combined with energy received from the transformer 304 and/or energy from the energy storage system 328. Accordingly, the controller 318 may couple the power combiner board 301 to one or more of the energy storage devices 328A-N and cause energy from the energy storage devices 328A-N to be provided to the power combiner board 301. The power combiner board 301 may be coupled to the multi-directional converter assembly 312 and convert DC energy into AC energy; such AC energy may then be provided to the power distribution board 308 such that the power distribution board 308 may provide AC energy out, to an electric vehicle charger for example.

As some electric vehicle chargers may take as input DC energy, the energy storage system 328 may provide as output DC energy to the power combiner board 301 where DC energy is combined; such energy may then be provided as output and provided to an electric vehicle charger. In examples, the controller 318 may configure the energy storage and conversion system 300 depending on the requirements of an electric vehicle charger.

As previously discussed, the controller 318 may communicate or otherwise interface with the site controller 320, which may be the same as or similar to the site controller 124 previously described. In examples, the controller 318 may wirelessly communicate with the site controller 320 such that the energy conversion and storage system 300 is contained within a contained environment, such as a container 132. In other examples, the controller 318 may communicate with the site controller 320 using another form of communication medium, such as a communication wireline.

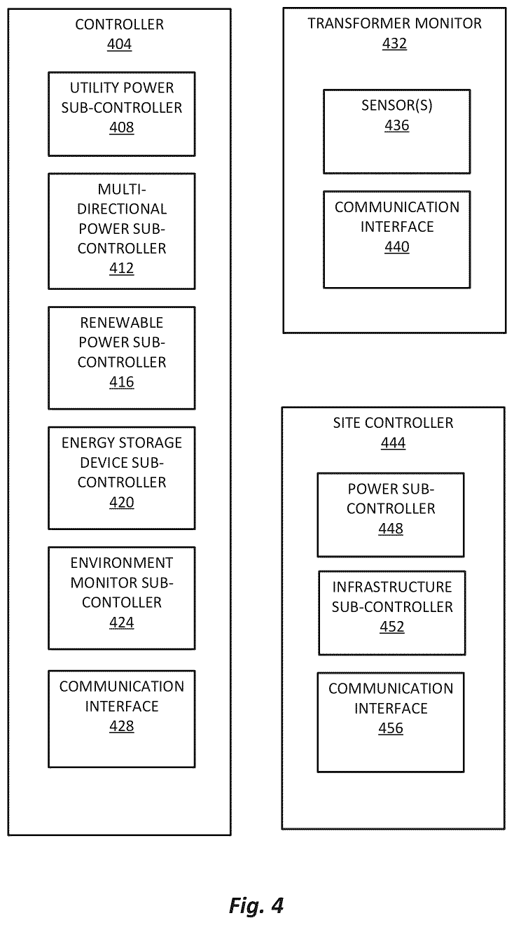

FIG. 4 depicts additional details of a controller 404, transformer monitor 432, and site controller 444, in accordance with examples of the present disclosure. The controller 404 may be the same as or similar to the controller 148 (FIG. 1). The controller 404 may include a utility power sub-controller 408 configured to determine an amount of power received from and/or capable of being received from a transformer, such as the transformer 116. The multi-directional power sub-controller 412 may be configured to control one or more multi-directional converters; in examples, the multi-directional sub-controller 412 may control which multi-directional converter converts AC to DC, DC to AC, and/or whether such multi-directional converter is operational (e.g., turned on or off). The renewable power sub-controller 416 may control a power converter, such as the power converter 316 to determine whether such energy received from the renewable energy source 314 is to be converted from one form to another. The energy storage device sub-controller 420 may determine or otherwise control which energy storage device (e.g., 328A-328N) is to receive energy from the power combiner board 301. In examples, the energy storage device sub-controller 420 may also determine a state of charge (SOC) for each of the energy storage devices (e.g., 328A-328N) and/or the energy storage system 328. The environment monitor sub-controller 424 may determine and control environmental conditions within the energy conversion and storage system. In examples where the energy conversion and storage system is within a container, the environment monitor sub-controller 424 may monitor temperature, humidity, pressure, etc. and cause one or more environmental systems (e.g., cooler, heater, one or more valves, etc.) to engage or disengage to maintain one or more parameters of an operating environment. The communication interface 428 may be wireless, wireline, and/or may configure the controller 404 to communicate with a network, such as the internet.

The transformer monitor 432 may monitor one or more aspects of a transformer provided by an electrical utility provider. In examples, the transformer monitor 432 may include one or more sensors 436 for monitoring one or more characteristics of the transformer. For example, an ammeter may monitor a current flowing through the transformer and a voltage meter may measure a voltage of the transformer. Similar to the controller 404, the transformer monitor 432 may include a communication interface 440. The communication interface 440 may be wireless, wireline, and/or may configure the transformer monitor 432 to communicate with a network, such as the internet. In accordance with examples of the present disclosure, the transformer monitor 432 may be a monitor and/or a meter such that the one or more sensors 436 provide information about the power provided by a transformer even if the transformer monitor 432 is not included within a transformer.

The site controller 444 may be the same as or similar to the site controller 124 (FIG. 1). In examples, the site controller 444 may include a power sub-controller 448, where the power sub-controller 448 may measure, determine, and/or control an amount of power provided to infrastructure components, such as a storefront, liquid fuel pumps, chillers, lights, etc. In examples, the site controller 444 may include an infrastructure sub-controller 452 for controlling one or more infrastructure components, including but not limited to liquid fuel pumps, environmental tank gauges, HVAC systems, beverage coolers, etc. Similar to the controller 404, the site controller 444 may include a communication interface 456. The communication interface 456 may be wireless, wireline, and/or may configure the site controller 444 to communicate with a network, such as the internet and/or communicate directly with the controller 404. For example, the communication interface 456 may allow sensed and/or measured information to be provided to or otherwise communicated to a processing location, such as a cloud-accessible data center. Accordingly, real-time information concerning power usage and/or power quality specific to one or more components of the fueling station 104 (e.g., electric vehicle charger, bank of electric vehicle chargers, storefront power usage, etc.) may be obtained at a location that is different from the fueling station 104. Moreover, the communication interface 456 may receive one or more instructions consistent with performing remote diagnostic testing and/or troubleshooting such that one or more components (e.g., transformer, power distribution board, electric vehicle charger, etc.) may be evaluated prior to and/or instead of dispatching a service vehicle or service individual thereby allowing for faster troubleshooting and increased availability or uptime offered by the electric vehicle charger.

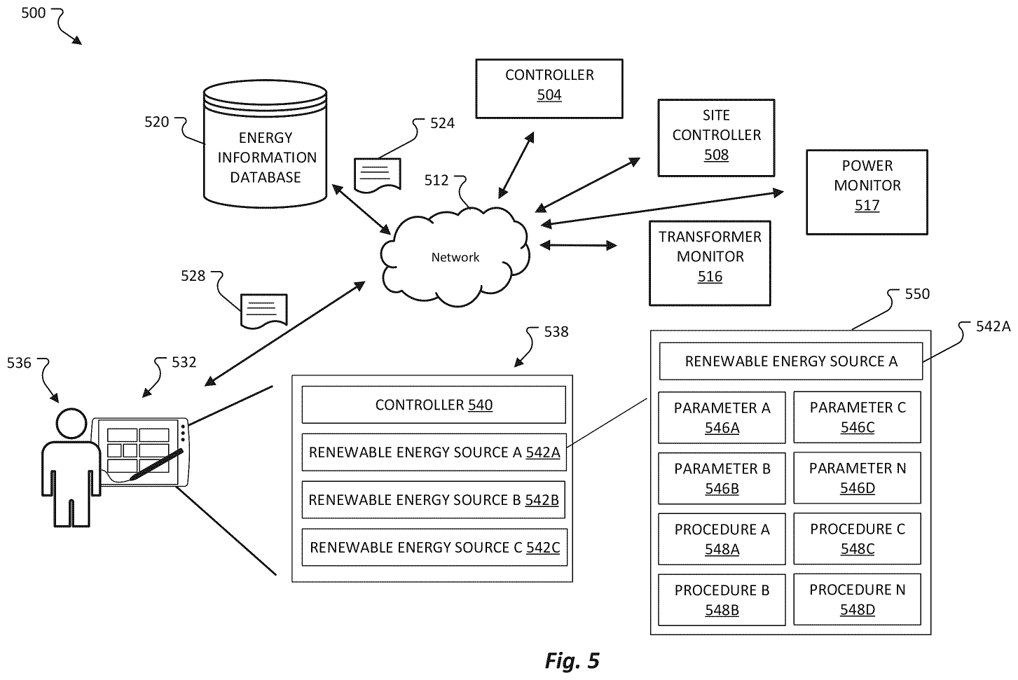

FIG. 5 depicts details directed to controlling one or more of the controller 504, site controller 508, and/or transformer monitor 516. In examples, a user 536 may interact with a computing device, such as but not limited to a tablet 532, to control one or more aspects of the controller 504, the site controller 508, and/or the transformer monitor 516. For example, a user 536 may configure one or more energy usage algorithms, procedures, or parameters utilizing a graphical user interface output to the computing device 532. Thus, for example, a user 536 may request energy information from an energy information database 520, where such information may include but is not limited to energy pricing information, energy contract information, electrical vehicle charger power use information, energy consumption information for the fueling station, and renewable energy source information. In examples, such information may be sent as and/or received as information 524 and 528, where information 528 may be directed to/from the computing device 532. In examples, the computing device 532 may communicate with the energy information database 520, the controller 504, the site controller 508, and/or the transformer monitor 516.

In examples, a graphical user interface including 538 may allow a user 536 to configure one or more controllers and/or sub-controllers previously described. For example, a user 536 may interact with a graphical user interface 538 that includes configuration information for a controller 540 as well as one or more renewable energy sources 542A-C. As further depicted in the graphical user interface 550, the renewable energy source a 542A may allow a user to configure one or more parameters 546A-D and one or more algorithms/procedures 548A-548D. For example, the one or more parameters and the one or more algorithms/procedures 548A-548D may determine when energy from the electrical utility provider should be used to charge the energy storage devices, when energy from the renewable energy source should be used to charge the energy storage devices, when to combine energy from the energy storage devices with energy from the electrical utility provider and/or energy from the renewable energy source, etc. In some examples, the determination as to when and what power source should be used may be based on one or more efficiency considerations and/or an energy capability provided to an electric vehicle charger. For example, when providing energy to a level 3 electric vehicle charger, the energy storage devices may be used together with another source of energy (e.g., electrical utility provider/renewable power source).

In examples, the graphical user interface including 538 may allow a user 536 to configure and/or interact with one or more controllers and/or sub-controllers previously described. For example, a user 536 may interact with a graphical user interface 538 that includes viewing power analysis information (including but not limited to current by phase, power factor by phase, power factor vs. current, voltage, incoming utility power status, max average power, etc.) and transaction information (including but not limited to: energy consumption, charge duration, electric vehicle charger state, max average power consumed, daily/weekly usage, accumulated energy per post, etc.). In addition, a graphical user interface 538 for example may allow the user 536 to perform remote diagnostics involving one or more of the components depicted in FIG. 5 and/or an electric vehicle charger/post/bank of posts. In some examples, a user 536 may cause a command, such as a reset protocol, to be performed by the electric vehicle charger/post/bank. In some examples, the user 536 may cause a safety command, such as a disconnect protocol, to be performed by the controller 504, site controller 508, transformer monitor 516, power monitor 517, etc. Accordingly, power specific to a component, such as a charging post, may be disconnected automatically or via the user 536 executing such command. The user interface may provide user-friendly access to monitoring information including transaction analysis, energy consumption, charge duration, EV charger state, utility power monitoring, and further allow a user to visualize an entire network geographically in a single map view to visually confirm the status of all chargers and quickly key in on those that may require attention or maintenance.

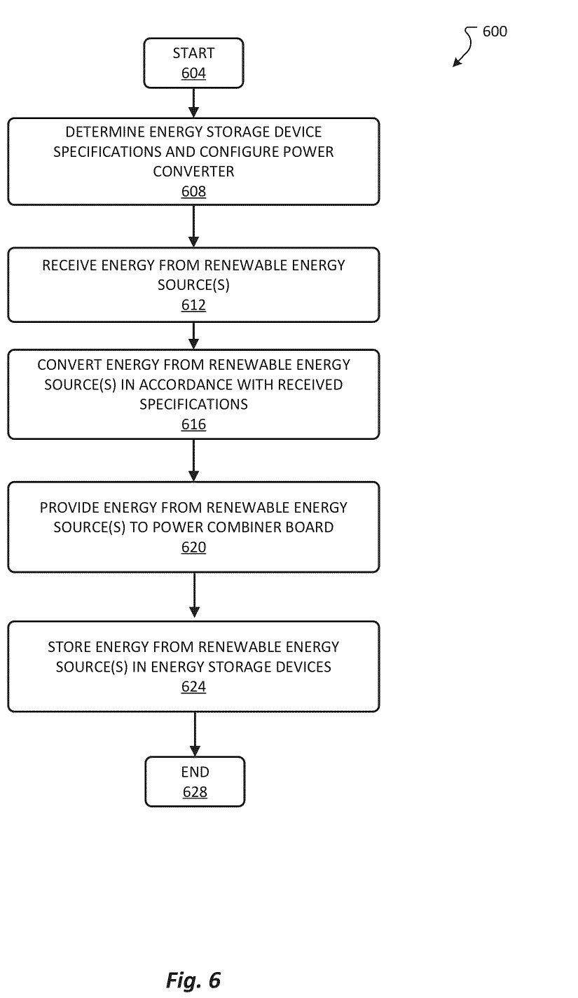

Referring now to FIG. 6, a detailed method for charging or otherwise storing energy in one or more energy storage devices, such as but not limited to one or more energy storage devices 328A-N, in accordance with examples of the present disclosure is provided. A general order for the steps of a method 600 is shown in FIG. 6. Generally, the method 600 starts at 604 and ends at 628. The method 600 may include more or fewer steps or may arrange the order of the steps differently than those shown in FIG. 6. The method 600 can be executed as a set of computer-executable instructions executed by a computer system and encoded or stored on a computer readable medium. In the illustrative aspect, the method 600 is executed by a controller (e.g., controller 318 and/or 320). However, it should be appreciated that aspects of the method 600 may be performed by one or more other processing devices, such as a computing device or server. Further, the method 600 can be performed by gates or circuits associated with a processor, Application Specific Integrated Circuit (ASIC), a field programmable gate array (FPGA), a system on chip (SOC), a neural processing unit, or other hardware device. Hereinafter, the method 600 shall be explained with reference to the systems, components, modules, software, data structures, user interfaces, etc. described in conjunction with FIGS. 1-5.

The method 600 starts at 604, where flow may proceed to 608. At operation 608, a controller may determine or otherwise identify energy storage device specifications. Thus, the controller may configure a power converter, such as the power converter 316, to receive energy from a renewable energy source and to provide energy, of the right voltage and current type to the power combiner board and/or the multi-directional power conversion device 326A. The method 600 may proceed to 612, where the energy from one or more renewable energy sources, such as the renewable energy source 314, may be received. The method 600 may proceed to 616 where the received energy from the one or more renewable energy sources is converted in accordance with the previously determined and/or identified specifications. For example, where the renewable energy source 314 provides power in the form of DC energy, the power converter, such as the power converter 316, may convert the energy from DC into AC. Alternatively, or in addition, the power converter 316 may convert the received energy into a higher voltage, for example by using a direct current boost converter.

The method 600 may proceed to 620 where the converted energy from the renewable energy source is provided to the power combiner board, for example the power combiner board 301. In examples, the energy from the renewable energy source 314 may first be provided to a multi-directional power conversion device 326A for example. The multi-directional power conversion device 326A may convert the received energy into direct current. The method 600 may then proceed to 624 where the direct current energy is then stored in one or more energy storage devices for example energy storage device 328A. The method may then end at 628.

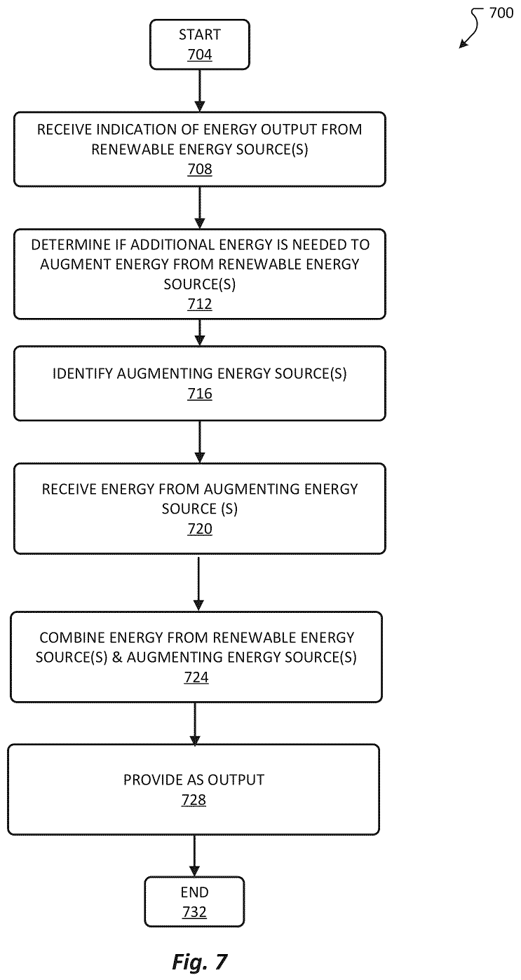

Referring now to FIG. 7, a detailed method for providing energy from an energy conversion and storage system is described in accordance with examples of the present disclosure. A general order for the steps of a method 700 is shown in FIG. 7. Generally, the method 700 starts at 704 and ends at 732. The method 700 may include more or fewer steps or may arrange the order of the steps differently than those shown in FIG. 7. The method 700 can be executed as a set of computer-executable instructions executed by a computer system and encoded or stored on a computer readable medium. In the illustrative aspect, the method 700 is executed by a controller (e.g., controller 318 and/or 320). However, it should be appreciated that aspects of the method 700 may be performed by one or more other processing devices, such as a computing device or server. Further, the method 700 can be performed by gates or circuits associated with a processor, Application Specific Integrated Circuit (ASIC), a field programmable gate array (FPGA), a system on chip (SOC), a neural processing unit, or other hardware device. Hereinafter, the method 700 shall be explained with reference to the systems, components, modules, software, data structures, user interfaces, etc. described in conjunction with FIGS. 1-6.

The method 700 starts at 704, where flow may proceed to 708. At operation 708, a controller may determine or otherwise identify energy storage device specifications. Thus, the controller may configure a power converter, such as the power converter 316, to receive energy from a renewable energy source and to provide energy, of the right voltage and current type to the power combiner board and/or the multi-directional power conversion device 326A. Further, the method 700 may receive an indication, such as an amount of energy, output or otherwise capable of being provided by the renewable energy source, such as the renewable energy source 314.

The method 700 may then proceed to 712 where the controller may determine if additional energy is needed to augment the energy capable of being provided by the renewable energy source, such as the renewable energy source 314. For example, if the renewable energy source 314 is capable of providing 60 kVA but an electric vehicle charger requires 192 kVA, then the controller may determine at 712 that additional energy is needed. Accordingly, at 716, the controller may identify additional energy sources to augment the energy provided by the renewable energy device. In examples, the augmenting energy sources may include, but are not limited to the electric storage device and/or energy from the electric utility provider. Accordingly, at 720, the controller may configure one or more components of the energy conversion and storage system such that augmenting energy is received. As an example, the controller may cause the energy storage devise 328A-D to output DC energy to the power combiner board 301; the controller may then configure the multi-dimensional power converters 326A-N to convert the DC energy into AC energy and provide the energy to the power distribution board. Accordingly, energy from the renewable energy source 314 may be provided to the power distribution board 308 via the multi-directional power conversion device 326A for example. At 724, the augmenting energy source is combined with the renewable energy source such that the energy is provided as output via the power distribution board 308 at method step 728 for example. The method 700 may then end at 732.

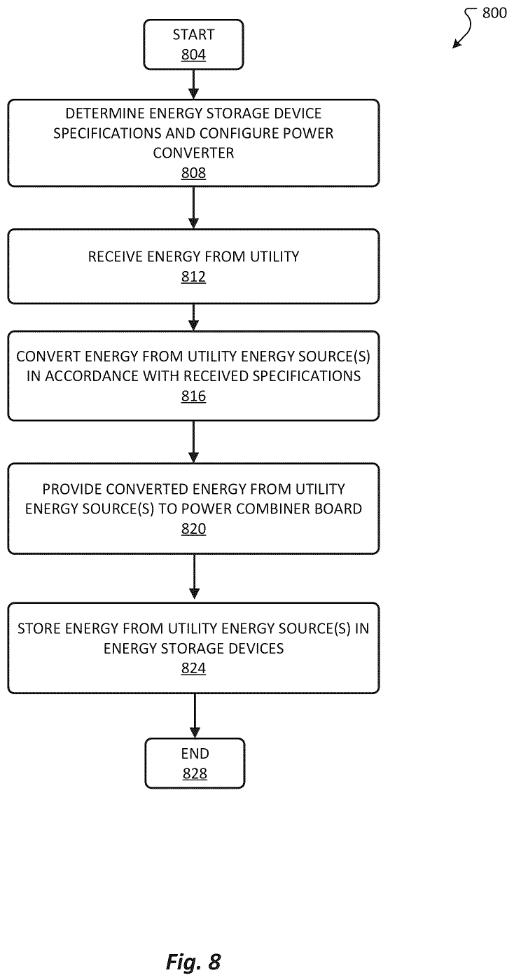

Referring now to FIG. 8, a detailed method for providing energy from an energy conversion and storage system is described in accordance with examples of the present disclosure. A general order for the steps of a method 800 is shown in FIG. 8. Generally, the method 800 starts at 804 and ends at 828. The method 800 may include more or fewer steps or may arrange the order of the steps differently than those shown in FIG. 8. The method 800 can be executed as a set of computer-executable instructions executed by a computer system and encoded or stored on a computer readable medium. In the illustrative aspect, the method 800 is executed by a controller (e.g., controller 318 and/or 320). However, it should be appreciated that aspects of the method 800 may be performed by one or more other processing devices, such as a computing device or server. Further, the method 800 can be performed by gates or circuits associated with a processor, Application Specific Integrated Circuit (ASIC), a field programmable gate array (FPGA), a system on chip (SOC), a neural processing unit, or other hardware device. Hereinafter, the method 800 shall be explained with reference to the systems, components, modules, software, data structures, user interfaces, etc. described in conjunction with FIGS. 1-7.

The method 800 starts at 804, where flow may proceed to 808. At operation 808, a controller may determine or otherwise identify energy storage device specifications. Thus, the controller may configure the multi-dimensional power converters 326A-N to receive energy from the electrical utility provider and to provide energy, of the right voltage and current type to the power combiner board 301. At 812, energy from the electrical utility provider may be received. At 816, the one or more multi-port power conversion devices 326A-N may convert the energy received from the electrical utility provider in accordance with the determined or otherwise identified energy storage device specifications. At 820, the converted energy may be provided to the power combiner board, such as the power combiner board 301, and then stored in the one or more energy storage devices 328A-N at step 824. The method 800 may then end at 828.

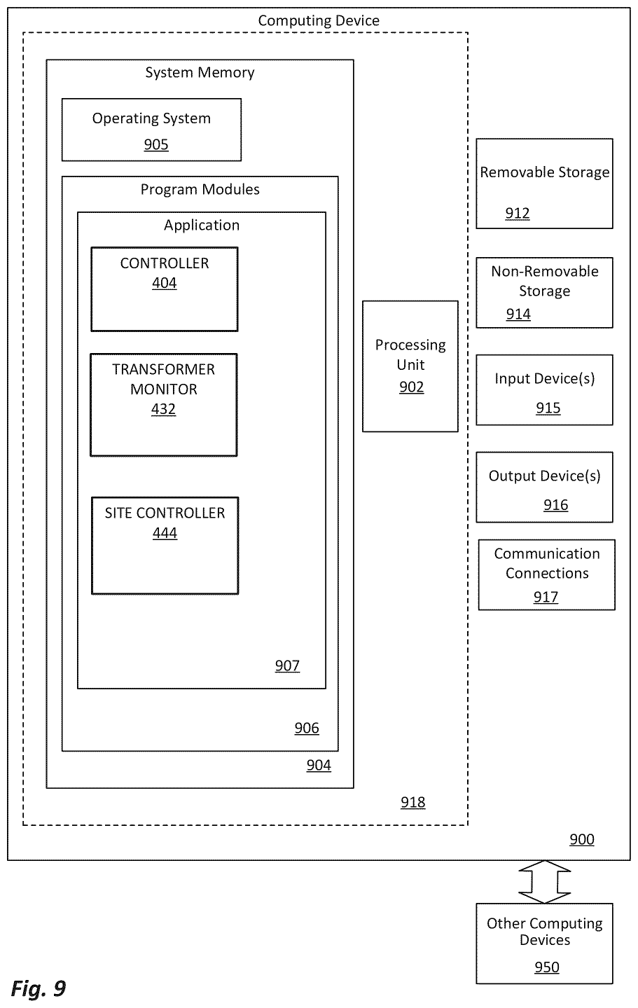

FIG. 9 is a block diagram illustrating physical components (e.g., hardware) of a computing device 900 with which aspects of the disclosure may be practiced that can perform one or more control operations specific to the energy storage controller, the site controller, and/or the transformer monitor. The computing device components described below may be suitable for the computing devices described above. For example, the computing device 900 may represent the computing device 532 of FIG. 5 and/or may be suitable for executing one or functions of the controller 504, the site controller 508, and the transformer monitor 516. In a basic configuration, the computing device 900 may include at least one processing unit 902 and a system memory 904. Depending on the configuration and type of computing device, the system memory 904 may comprise, but is not limited to, volatile storage (e.g., random access memory), non-volatile storage (e.g., read-only memory), flash memory, or any combination of such memories.

The system memory 904 may include an operating system 905 and one or more program modules 906 suitable for performing the various aspects disclosed herein such. The operating system 905, for example, may be suitable for controlling the operation of the computing device 900. Furthermore, aspects of the disclosure may be practiced in conjunction with a graphics library, other operating systems, or any other application program and is not limited to any particular application or system. This basic configuration is illustrated in FIG. 9 by those components within a dashed line 918. The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by a removable storage device 912 and a non-removable storage device 914.

As stated above, several program modules and data files may be stored in the system memory 904. While executing on the at least one processing unit 902, the program modules 906 may perform processes including, but not limited to, one or more aspects, as described herein. The application 907 includes a controller 404, transformer monitor 432, and site controller 444, together with one or more components as described in FIG. 4.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 900 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The computing device 900 may also have one or more input device(s) 915 such as a keyboard, a mouse, a pen, a sound or voice input device, a touch or swipe input device, etc. The output device(s) 916 such as a display, speakers, a printer, etc. may also be included. The aforementioned devices are examples and others may be used. The computing device 900 may include one or more communication connections 917 allowing communications with other computing devices 950. Examples of suitable communication connections 917 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 912, and the non-removable storage device 914 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 900. Any such computer storage media may be part of the computing device 900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

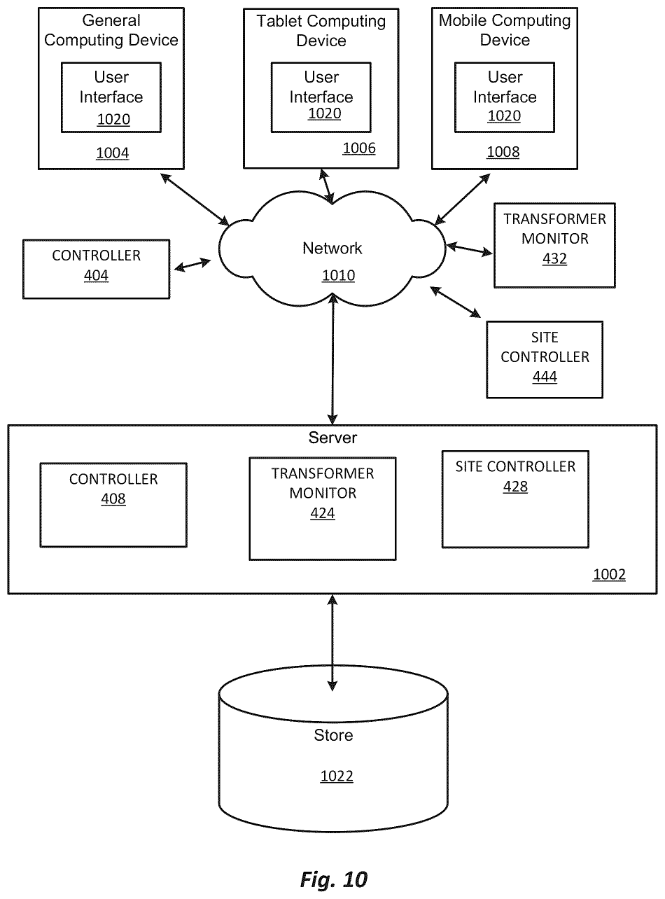

FIG. 10 illustrates one aspect of the architecture of a system for processing data received at a computing system from a remote source, such as a personal computer 1004, tablet computing device 1006, or mobile computing device 1008, as described above. The personal computer 1004, tablet computing device 1006, or mobile computing device 1008 may include a user interface 1020 allowing a user to interact with one or more program modules as previously described. One or more of the previously described program modules 906 or software applications 907 may be employed by server device 1002 and/or the personal computer 1004, tablet computing device 1006, or mobile computing device 1008, as described above. For example, the server device 1002, may include a controller 404, a transformer monitor 432, and a site controller 444 as previously mentioned. In some examples, one or more of the controller 408, the transformer monitor 432, and/or the site controller 444 may be separate and independent of the server 1002.

In some examples, the server device 1002 may provide data to and from a client computing device such as a personal computer 1004, a tablet computing device 1006 and/or a mobile computing device 1008 (e.g., a smartphone) through a network 1010. By way of example, the computer system described above may be embodied in a personal computer 1104, a tablet computing device 1106 and/or a mobile computing device 1108 (e.g., a smartphone). Any of these examples of the computing devices may obtain content from the store 1022, where the store may include energy information from an energy information database, such as the energy information database 520.

The site controller 124, 220, and/or 320 may perform functions and/or capabilities that are the same as or similar to the Franklin Fueling Systems EVO™ 200, EVO™ 400, EVO™ 550, EVO™ 5000, EVO™ 650, EVO™ 6000 Automatic Tank Gauges. Additional information for the EVO™ series automatic tank gages can be found in the FFS-0792 EVO Series Brochure.pdf, FFS-0618 EVO 200 & EVO 400 ATG Datasheet.pdf, FFS-0791 EVO Series Selection Guide.pdf, FFS-0846 EVO Series Flow Rate Monitoring Brochure & Ordering Guide.pdf, 228180003-EVO-200-and-EVO-400-Automatic-Tank-Gauge-Installation-Guide.pdf, 228180015-r1-EVO-200-and-EVO-400-Automatic-Tank-Gauges-Programming-Guide.pdf, 228180016-r1-EVO-200-and-EVO-400-Automatic-Tank-Gauges-Operation-Guide.pdf, FFS-0620 EVO 550 & EVO 5000 ATG Datasheet.pdf, 000-2173rB-TS-550_5000-evo-Programming.pdf, 000-2171-EVO-550-EVO-5000-Operators-Guide.pdf, 000-2170rD-T5EVO-Install.pdf, FFS-0743 EVO 600 & 6000 ATG Datasheet.pdf, 10000002562-EVO-6006000-Automatic-Tank-Gauges-Operation-Guide.pdf, 228180033-EVO-6006000-ATG-Installation-Guide.pdf, and 228180061-EVO-600-6000-Programming-Guide.pdf documents, the entire contents of which are hereby incorporated by reference, in their entirety, for all purposes and all that they teach.

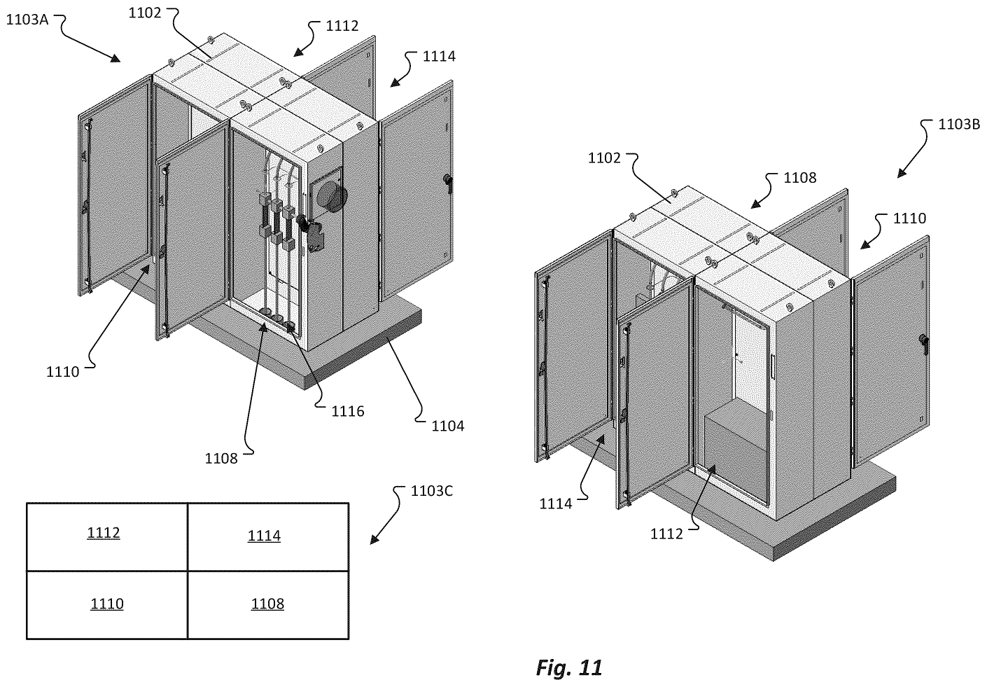

FIG. 11 depicts details of an integrated power distribution utility panel 1102 in accordance with examples of the present disclosure. Multiple power-related cabinets located at a site may be condensed into a single integrated power distribution utility panel 1102 and may include one or more components depicted and described in FIGS. 1-5. The integrated power distribution utility panel 1102 may be divided into a plurality of regions 1108-1114; each region of the plurality of regions 1108-1114 may correspond to a separate panel area and may house or otherwise include one or more components. Each region of the plurality of regions 1108-1114 may be separate and distinct from and/or physically isolated from one another and access thereto may be restricted or otherwise controlled. The integrated power distribution utility panel 1102 may be configured with components based on the site, location, and/or fueling station 104 at which it is installed. For example, a first panel area 1108 may be a dedicated panel area for utility only access and may include one or more components for access only by the utility. The first panel area 1108 may include a current transformer (CT) and an associated CT socket. A second panel area 1110 may be a circuit breaker panel and include one or more smart contact breakers or other remote controllable contactors for power cycling one or more loads, such as an EV load which may be controlled by the site controller 220 or controller 320. Accordingly, one or more components in the integrated power distribution utility panel 1102 may be connected to a network for communicating with other network connected devices. If a site controller 220 or controller 320 is located at a different location than the integrated power distribution utility panel, the site controller 220 or controller 320 may control at least one aspect of the integrated power distribution utility panel 1102 utilizing such network connection. A third panel area 1114 may include one or more multi-directional power converter assemblies, such as the multi-directional power converter assembly 312, together with a power meter. Accordingly, power generated by one or more renewable sources, such as the renewable sources 214 and/or 314, can be monitored to determine if power should be routed to an EV charger or routed to the energy storage system, such as the energy storage system 212 and/or 328. A fourth panel area 1112 may include one or more components of the energy storage system 212 and/or 328. For example, the fourth panel area 1112 may include one or more energy storage devices 328A-N. In some examples, a region of the plurality of regions 1108-1114 may include many components, such as the controllers, power combiner boards, multi-directional converters, disconnects, and/or buses. In some examples, the integrated power distribution utility panel 1102 may include more regions than illustrated in FIG. 11; in some examples, the integrated power distribution utility panel 1102 may include fewer regions than illustrated in FIG. 11. For example, the integrated power distribution utility panel 1102 may include two, three, four, five, six, seven, eight, nine, or ten regions. In other examples, one or more of the plurality of regions 1108-1114 may include a single component.

The integrated power distribution utility panel 1102 may include combined or separate panel areas for utility only access; a current transformer (CT) meter and meter socket; distribution circuits that are dedicated to the EV loads (e.g., 480V circuits); one or more controllers; and/or one or more connections to existing on-site systems, such as but not limited to liquid petroleum pumps, tanks, and/or monitoring systems. In some examples, the integrated power distribution utility panel 1102 may include one or more configurable options such as but not limited to (i) separate panels from 240V circuits; (2) an integrated transformer, such as but not limited to the transformer 204 and/or 304; (3) separate metered panel area for non-EV loads; (4) integration of the renewable energy sources and/or energy storage systems/devices through one or more multi-directional converter assemblies (e.g., DC/AC converter) via an AC bus; and (5) remote controllable contactors for power cycling one or more loads, such as an EV load which may be controlled by the site controller 220 or controller 320. In some examples, the integrated power distribution utility panel 1102 may include a service disconnect. The integrated power distribution utility panel 1102 may be dropped in place to replace multiple cabinet assemblies and/or may be quicker and easier to install and permit.

As depicted in FIG. 11, a front view 1103A depicts a plurality of regions 1108, 1110, 1112, and/or 1114, where each region may include a separate door, cover, or access panel. As depicted in the region 1108, a panel area may include 408 volt 3 phase power 1116. A back view 1103B is further depicted in FIG. 11, whereby, similar to the front view 1103A, a separate door, cover, or access panel may protect and/or control access to one or more of the regions. The top view 1103C depicts an arrangement of the plurality of regions 1108-1114; as previously discussed, the integrated power distribution utility panel 1102 may include more or fewer regions than that which is depicted in FIG. 11. In some examples, each region 1108-1114 may be electrically and magnetically isolated from an adjacent region. During installation of the integrated power distribution utility panel 1102, the integrate power distribution utility panel 1102 may be placed on a single pad 1104 which may simplify the installation procedure.

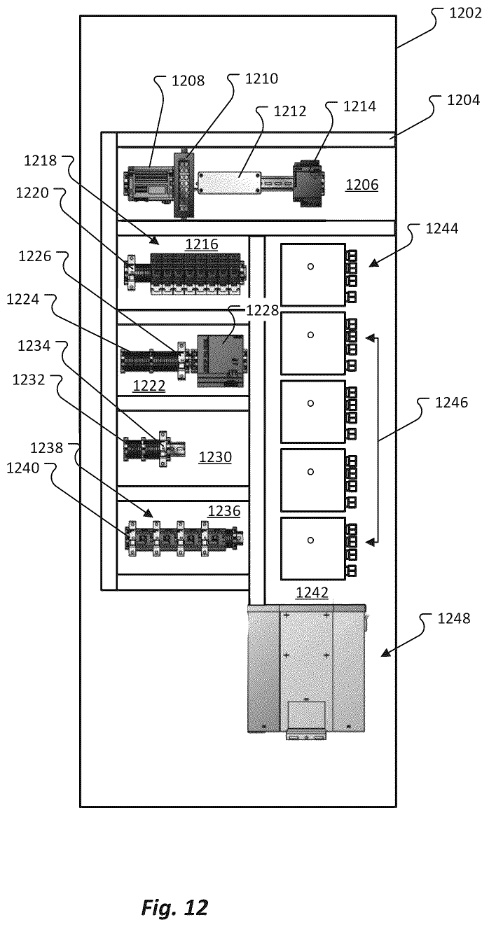

FIGS. 12-14 depict additional details of an example all-in-one switchgear panel containing the entire infrastructure required between a utility service and electric vehicle chargers. In examples, the all-in-one switchgear panel may combine a Current Transformer (CT) cabinet, 480 VAC 3-Phase breaker panel, 240/120 VAC single phase breaker panel, and transformer into a single enclosure. For example, the all-in-one switchgear panel depicted in FIGS. 12-14 may be the same as or similar to the integrated power distribution utility panel 1102. In examples, the all-in-one switchgear panel may include up to four 150 KW Level 3 DC fast chargers. Alternatively, or in addition, the all-in-one switchgear panel may include more than four 150 KW Level 3 DC fast chargers. Alternatively, or in addition, the all-in-one switchgear panel may include fewer than four 150 KW Level 3 DC fast chargers. Alternatively, or in addition, the all-in-one switchgear panel may include different types and sizes of electric vehicle charger. The switchgear may include grid intelligence for switchgear and EV charger remote monitoring and control. The switchgear may reduce and/or eliminate the lengthy design process of traditional post-and-frame systems, which require additional costs to design and source a mixed-manufacturer panel system. That is, the switchgear depicted in FIGS. 12-14 may require minimal on-site connections for the incoming power and outgoing charger connections, which may reduce on-site installation time and costs. In addition, the switchgear depicted in FIGS. 12-14 may include an embedded monitoring system to provide remote access to real-time switchgear and electric vehicle charger health data with remote power cycling capabilities and automated alarms to facilitate condition-based maintenance planning. For example, the switchgear depicted in FIGS. 12-14 may integrated emergency-stop capabilities for NFPA compliance and added safety capabilities including EV charger crash detection and flammable vapor monitoring with automatic shutdown and remote alerts. Thus, in support of the National Electric Vehicle Infrastructure (NEVI) Formula Program, the switchgear depicted in FIGS. 12-14 enables rapid deployment of the electric vehicle charging infrastructure by offering a turnkey switchgear solution that provides real-time monitoring and alerts, and providing evidence to achieve high availability and uptime, such as a 97% level.

In accordance with examples of the present disclosure, the switchgear depicted in FIG. 12 may include a health monitoring cabinet 1202. The health monitoring cabinet 1202 may include an area 1242 that includes one or more power and/or health monitors 1244 that monitors a main power supply, such as a power supply provided by a utility. The health monitoring cabinet 1202 may include one or more power and/or health monitors 1246 that monitor power provided to one or more electric vehicle chargers. Thus, an input/output module 1212 may receive power related information from the power and/or health monitors 1244 and/or 1246 and provide such information to a network component 1210, such as a network switch; the network component 1210 may be communicatively coupled to another network component, such as a wireless and/or cellular modem 1208 such that the wireless and/or cellular modem 1208 may communicate with a cloud-based infrastructure that processes and stores such information. In some examples, the health monitoring cabinet 1202 may include one or more energy reducing maintenance switches 1214 for disabling one or more of the components in the area 1206.

The health monitoring cabinet 1202 may include an area 1216 that includes circuit breakers 1220 and motor operated relays 1218 coupled to an electric vehicle charger power cabinet (e.g., 480 VAC power supply). The health monitoring cabinet 1202 may include an area 1222 that includes DC terminal blocks 1224, an AC to DC converter 1228, and a plurality of circuit breakers 1226. In some examples, the DC power provided by the AC to DC converter 1228 is 24 Volts, though other voltages may be provided. The DC voltage may be utilized to power one or more components in the health monitoring cabinet 1202. The health monitoring cabinet 1202 may include an area 1230 that includes AC terminal blocks 1232 and a plurality of circuit breakers 1234 for powering one or more components in the health monitoring cabinet 1202. The health monitoring cabinet 1202 may include an area 1236 that includes a plurality of electric vehicle charging post connectors 1240 for remotely power cycling one or more electric vehicle charging posts. The circuit breakers 1238 may be coupled to the electric vehicle charging post connectors to facilitate the remote power cycling. The health monitoring cabinet 1202 may include a transformer 1248 that converts an incoming electricity of a first voltage (e.g., 480 VAC) to electricity of a second voltage (e.g., 120 VAC). Each of the areas 1206, 1216, 1222, 1230, and 1236 may be isolated from one another via isolation and/or insulating material 1204.

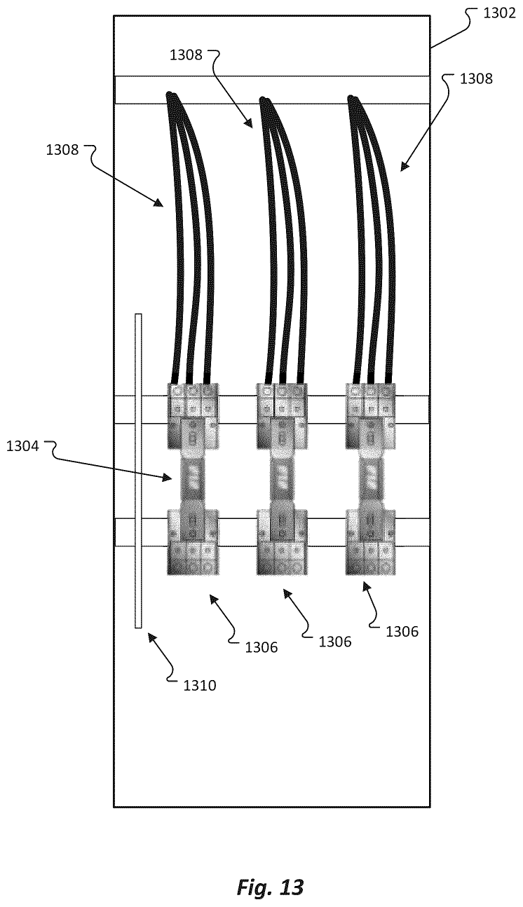

FIG. 13 depicts an example of a utility service cabinet 1302 in accordance with examples of the present disclosure. The utility service cabinet 1302 may be located within the same container or housing as the health monitoring cabinet 1202 but may be accessible via a different access panel. In examples, the utility service cabinet 1302 includes three phase main breaker feeder cables 1308 coupled to underground utility service connections 1306; such cables and service connections may be rated for three phase 480 VAC. The utility service cabinet 1302 may include a utility neutral connection 1310 and a plurality of current transformers 1304 for measuring current provided by the utility.

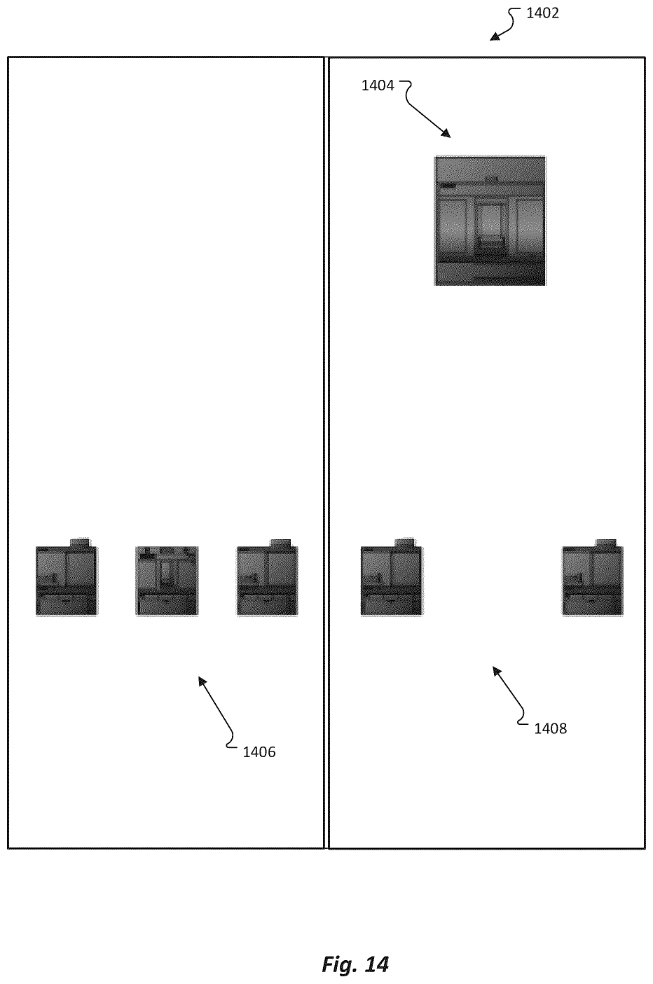

FIG. 14 depicts an example of a client power cabinet 1402 in accordance with examples of the present disclosure. The client power cabinet 1402 may be located within the same container or housing as the health monitoring cabinet 1202 but may be accessible via a different access panel. In examples, the client power cabinet 1402 includes a main service circuit breaker 1404 (e.g., 1000 Amp service circuit breaker), three phase branch circuits 1406, and electric vehicle charger power cabinet circuit breakers 1408.

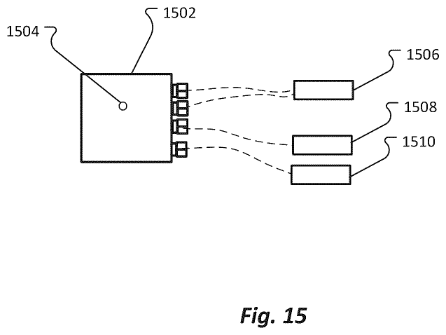

FIG. 15 depicts additional details of a power and/or health monitor 1502. The power and/or health monitor 1502 may be the same as or similar to the power and/or health monitors 1244 and/or 1246 previously described. The power and/or health monitor 1502 may provide continuous, meter-grade precision performance monitoring of switchgear and electric vehicle charger performance diagnostics and key state-of-health indicators. In examples, the power and/or health monitor 1502 includes voltage leads 1510 and split core cables 1506 for obtaining voltage and current readings. In some examples, the power and/or health monitor 1502 may include a network connection module 1508, such as an ethernet port, enabling the power and/or health monitor 1502 to communicate with one or more other network components. Further, the power and/or health monitor 1502 may include a diagnostic or status indicator 1504, such as an LED, that provides a visual status of the power and/or health monitor 1502.

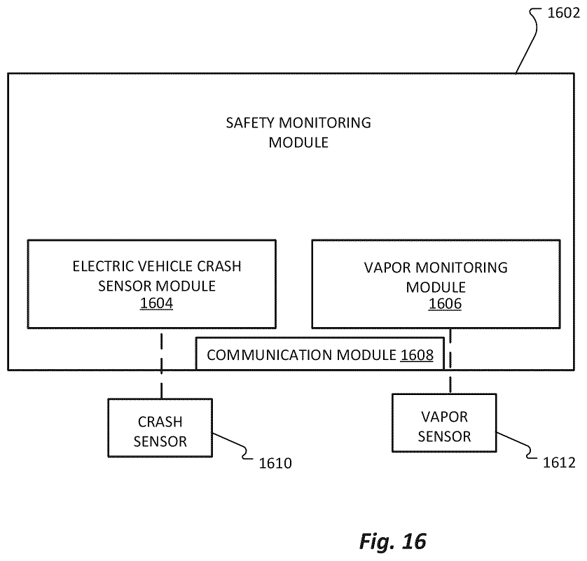

FIG. 16 depicts an example of a safety monitoring module 1602 in accordance with examples of the present disclosure. The safety monitoring module 1602 may integrate emergency-stop capabilities including EV charger crash detection and flammable vapor monitoring with automatic shutdown and remote alerts. In examples, the safety monitoring module 1602 may include an electric vehicle crash sensor module 1604, a liquid monitoring module 1605, a vapor monitoring module 1606, an emergency stop module 1607, and a communication module 1608. The crash sensor module 1604 may be coupled to one or more crash sensors 1610, where the one or more crash sensors 1610 may be utilized for determining if a charging cabinet and/or charging post is subjected to an impact or crash event. In examples, the one or more crash sensors 1610 may include, but is not limited to a tilt sensor, an impact sensor, and/or may refer to crash detection using video. The liquid monitoring module 1605 may be coupled to one or more liquid sensors 1611 which are configured to provide measurements of a level of liquid in a measured area. The one or more liquid sensors 1611 may have components located in a variety of locations including, but not limited to, the electric vehicle charger or panel 1102. The vapor monitoring module 1606 may be coupled to a plurality of vapor sensors 1612. The emergency stop module 1607 may be connected to one or more emergency stop devices 1613 which may be located in any of a variety of locations, including but not limited to the electric vehicle charger or panel 1102. In examples, if the crash sensor module 1604 determines that an impact event has occurred that is within a certain region of a site or impacts a specific charging post or charging cabinet, the safety monitoring module 1602 may cause the power to the affected component (e.g., charging post, charging cabinet, etc.) to be removed. That is, a communication module 1608 may communicate to the controller 408 or site controller 428 for example and cause one or more remote breakers or relays to disconnect electricity for the affected component. In some examples, a verification or feedback loop including one or more of the power and/or health monitor may confirm that no current is flowing to the affected component. Similarly, if the vapor monitoring module 1606 determines that an amount of vapor exceeds a certain threshold, the liquid monitoring module 1605 determines that an amount of fuel exceeds a certain threshold, or the emergency stop module 1607 receives an input from an emergency stop device 1613, the safety monitoring module 1602 may cause the power to one or more components (e.g., charging post, charging cabinet, etc.) with a certain area to be removed. That is, a communications module 1608 may communicate to the controller 408 or site controller 428 for example and cause one or more remote breakers or relays to disconnect electricity for a component in the affected area. In some examples, a verification or feedback loop including one or more of the power and/or health monitor may confirm that no current is flowing to the affected area.

Additionally, communications module 1608 may communicate with a user computing device such as computer device 532 described above having a graphic user interface such as graphic user interface 538 described above. In this manner a user may use the user computing device to perform remote diagnostics and/or control of the power distribution utility panel by sending commands to the communications module 1608 in the manner described herein.

In addition, the aspects and functionalities described herein may operate over distributed systems (e.g., cloud-based computing systems and/or network-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. An energy management system, comprising:
a power distribution board configured to receive AC energy from a transformer coupled to a first energy supply and to output energy to a vehicle charger;
a power converter assembly configured to receive AC energy through a first disconnect from the power distribution board and convert the AC energy to DC energy;
an energy storage system coupled to the power converter assembly to receive and store DC energy from the power converter assembly; and
a controller coupled to the power distribution board, the power converter assembly and the energy storage system, the controller being configured to cause the power converter assembly to receive DC energy from the energy storage system, convert the DC energy to AC energy, and provide the AC energy to the power distribution board;
wherein the power distribution board, the power converter assembly, the energy storage system and the controller are located within a container.

2. The energy management system of claim 1, further comprising a second disconnect connected between the transformer and the first energy supply.

3. The energy management system of claim 1, wherein the controller is further configured to cause the power converter assembly to receive DC energy from the energy storage system, convert the DC energy to AC energy, and provide the AC energy to the power distribution board for delivery through the first disconnect to the transformer and the first energy supply.

4. The energy management system of claim 1, further comprising a renewable energy source configured to provide energy through a power converter to the power converter assembly, wherein the controller is configured to cause the power converter assembly to deliver power received from the renewable energy source to the energy storage system.

5. The energy management system of claim 4, wherein the controller is configured to determine when a requisite amount of energy is available for a particular load from the renewable energy source and respond to such determination by causing the renewable energy source to provide energy through the power converter to the power distribution board instead of the energy storage system.

6. The energy management system of claim 4, wherein the controller is configured to cause the power distribution board to output energy to the vehicle charger including energy from the transformer and energy from the renewable energy source.

7. The energy management system of claim 6, wherein the energy from the renewable energy source output by the power distribution board is energy stored in the energy storage system.

8. The energy management system of claim 1, wherein the controller is configured to receive communications from one or more sensors associated with the vehicle charger and control operation of the energy management system in response to the communications.

9. The energy management system of claim 8, wherein the one or more sensors includes a vapor sensor that communicates a measurement to the controller of a combustible fuel vapor.

10. The energy management system of claim 8, wherein the one or more sensors includes a crash sensor that communicates a signal to the controller indicating an impact to the container and/or the vehicle charger.

11. The energy management system of claim 8, wherein the controller controls operation of the energy management system in response to the communications by automatically disconnecting energy supplied to the vehicle charger.

12. The energy management system of claim 8, wherein the one or more sensors includes a liquid sensor that communicates a measurement to the controller of a level of liquid in a measured area.

13. The energy management system of claim 1, wherein the controller includes an environment monitor sub-controller configured to monitor at least one of temperature, humidity and pressure within the container and to operate one or more environmental systems to maintain one or more parameters of an operating environment within the container.

14. The energy management system of claim 1, further comprising a user computing device having a graphical user interface configured for wireless communication via one or more communications networks with the controller and an information database to permit the user to access information from the information database and configure one or more parameters of operation of the energy management system based upon the accessed information.

15. The energy management system of claim 14, wherein the graphic user interface further permits the user to perform remote diagnostics and/or control of the energy management system by sending one or more commands to the controller via the one or more communications networks.

16. A power distribution utility panel, comprising:
a first panel area configured to be accessed only by personnel of a utility, the first panel area including a current transformer;
a second panel area including at least one remote controllable device for connecting and disconnecting power to/from one or more loads; and
a third panel area including at least one power converter assembly, a controller and a power meter configured to monitor power from a power source, the at least one power converter assembly being configured to route power from the power source to an electric vehicle charger and/or an energy storage system.

17. The power distribution utility panel of claim 16, further comprising a fourth panel area including the energy storage system which includes a plurality of energy storage devices.

18. The power distribution utility panel of claim 16, wherein each of the panel areas include a separate access panel and is electrically and magnetically isolated from adjacent panel areas.

19. The power distribution utility panel of claim 16, wherein the second panel area includes a one or more power and/or health monitors configured to monitor a main power supply from a utility and power provided to the electric vehicle charger.

20. The power distribution utility panel of claim 19, wherein the first panel area includes three phase main breaker feeder cables coupled to underground utility service connections.

21. The power distribution utility panel of claim 16, wherein the at least one remote controllable device includes at least one circuit breaker and at least one relay.

22. The power distribution utility panel of claim 16, further including a safety monitoring module including an electric vehicle crash sensor module, a vapor monitoring module, a liquid monitoring module, an emergency stop module, and a communications module.

23. The power distribution utility panel of claim 22, wherein the communications module is configured to communicate with a user computing device having a graphic user interface that permits the user to perform remote diagnostics and/or control of the power distribution utility panel by sending one or more commands to the communications module.

24. The power distribution utility panel of claim 22, wherein the electric vehicle crash sensor module is coupled to one or more crash sensors configured to sense an impact to the power distribution utility panel and/or the electric vehicle charger.

25. The power distribution utility panel of claim 22, wherein the vapor monitoring module is coupled to one or more vapor sensors configured to measure an amount of a flammable vapor in a vicinity of the power distribution utility panel.

26. The power distribution utility panel of claim 22, wherein the liquid monitoring module is coupled to one or more liquid sensors configured to measure a level of liquid in a measured area.

27. The power distribution utility panel of claim 26, wherein the one or more liquid sensors are disposed in one of the electric vehicle charger or the power distribution utility panel.

28. The power distribution utility panel of claim 22, wherein the emergency stop module is configured to communicate via the communications module with the controller to cause electricity to be disconnected from the electric vehicle charger based upon inputs from the electric vehicle crash sensor module and/or the vapor monitoring module.

29. The power distribution utility panel of claim 28, wherein the emergency stop module communicates via the communication module with the controller to cause electricity to be disconnected from the electric vehicle charger based upon an emergency stop input from an emergency stop device located on at least one of the electric vehicle charger and the power distribution utility panel.

30. A method of managing energy distribution, comprising:
determining, by a controller, energy storage specifications;
configuring, by the controller, a power converter based upon the determined energy storage specification to receive energy from a renewable energy source and to provide energy to a power conversion device;
converting, by the power conversion device, the received energy from a first form to a second form and/or to a different voltage based upon the energy storage specifications;
providing the converted energy to a power combiner board; and
storing energy received from the power combiner board in an energy storage device.
